(19) United States
(12) Patent Application Publication
(10) Pub. No.: US 2021/0159478 A1
(43) Pub. Date: May 27, 2021

(54) BATTERY CELL WITH ELECTRODE HAVING CONTINUOUS TAB

(71) Applicant: Edward Buiel Consulting LLC, Chattanooga, TN (US)

(72) Inventors: Edward R. Buiel, Chattanooga, TN (US); Joseph Turner, Apison, TN (US); Shawn P. McMahon, Signal Mountain, TN (US)

(73) Assignee: Edward Buiel Consulting LLC, Chattanooga, TN (US)

(21) Appl. No.: 17/100,103

(22) Filed: Nov. 20, 2020

Related U.S. Application Data
(60) Provisional application No. 62/938,524, filed on Nov. 21, 2019.

(51) Int. Cl. H01M 2/26; H01M 2/16; H01M 10/04; H01M 4/36

(52) U.S. Cl. CPC H01M 2/263; H01M 4/366; H01M 10/0431; H01M 2/1673

(57) ABSTRACT

An electrode assembly includes a first substrate, a first active material composite coating the first substrate, a first electrode tab is formed by an uncoated portion of the first substrate that extends continuously between a first end and a second end of the first substrate. The assembly further includes a second elongate substrate, a second active material composite coating the second substrate, and a second electrode tab formed by an uncoated portion of the second substrate that extends continuously between a first end and a second end of the second substrate. An electrically-insulative separator is between the first substrate and the second substrate. The first substrate and second substrate, stacked together with the separator located between them, are then rolled about a central axis to form a jelly roll.

### CROSS REFERENCE TO RELATED APPLICATIONS

This application claims the benefit of U.S. Provisional Patent Application No. 62/938,524, filed on Nov. 21, 2019, and entitled SECONDARY BATTERY WITH ELECTRODE HAVING CONTINUOUS TAB, which is incorporated herein by reference in its entirety.

### FIELD

This invention relates generally to cells for energy storage devices. More particularly, the present invention relates to electrodes having a continuous tab, a secondary battery that utilizes electrodes having continuous tabs, and a method of producing the same.

### BACKGROUND

With initial reference to FIGS. 1 and 2, two electrically-conductive plate-shaped electrodes 100 and 102 and an electrically insulative separator 104, which are conventionally stacked and wound to form a jelly roll-type electrode assembly 106, are shown. Separator 104 electrically isolates electrode 100 from electrode 102 to prevent a short circuit from occurring. As such, separator 104 is typically wider than both of the electrodes 100, 102 in transverse direction 118) in order to isolate the electrodes. Each of the electrodes 100, 102 is formed by coating a collector plate or current collector with an active material composite, including either a positive electrode active material composite or a negative electrode active material composite. Certain non-coated portions 108 of the electrodes 100, 102 are not coated with the active material composite. Conventionally, one or more ribbon-like electrode tabs 110, 112 are connected to each of the electrodes 100, 102, respectively, at these non-coated portions 108. Typically, these electrode tabs 110, 112 are located at either the end or the middle of the wound electrode. These tabs 110, 112 are typically welded then taped to the electrodes 100, 102. This is a time consuming and labor-intensive process that frequently requires specialized machines and fabrication techniques. The addition of tabs can cause defects and/or discontinuities within the roll. For example, failing to properly connect electrode tabs 110, 112 to electrodes 100, 102 can cause the wound roll (i.e., electrode assembly 106) to be “out of round” or misshapen. It can also cause areas of high pressure within the roll that can impact the ionic transport within the separator and/or electrodes. Frequently one tab 110 extends from one side 116 of one of the electrodes 100, across the electrode in transverse direction 118, and then away from an opposing side 114. Another tab 112 extends away from one side 114 of the other electrode 102, across the electrode in direction 118, and then away from opposing side 116. Direction 118 is typically orthogonal to the direction that the electrodes 100, 102 are rolled to form the electrode assembly 106 (i.e., direction 120).

As shown in FIG. 3, once electrode assembly 106 is formed, electrode tabs 110, 112 are passed through insulating discs 122. The entire assembly is then inserted into a can 124 via a top opening 126. Electrode tab 112 extends towards a closed bottom end 128 of the can 124 and electrode tab 110 extends towards the top opening 126 of the can. Once the electrode assembly 106 has been fully inserted into the can 124, a bottom end 130 of the electrode assembly 106 rests on one of the insulating discs 122, which rests on the bottom end 128 of the can 124. A crimp 132 may be formed around a top end of the can 124 to secure the electrode assembly 106 within the can.

Each of the insulating discs 122 has a central opening 134 that, when the electrode assembly 106 is inserted into the can 124, is aligned with a corresponding central hollow 136 formed in the electrode assembly. In other cases, discs 122 might include openings that allow tabs to exit in the center of the wound electrode assembly 106. Electrode tab 112 is bent towards the central opening 134 of the bottom insulating disc 122. A welding rod may then be inserted through the aligned central openings 134 of the insulating discs and central hollow 136 of the electrode assembly 106 to weld electrode tab 112 to the bottom end 128 of the can 124. Alternatively, a laser welder may be directed through the same aligned openings 134 and central hollow 136 to form the weld. Alternatively, electrode tab 112 may be welded to the bottom end 128 of can 124 by externally contacting the bottom end of the can with the welder. In this way, can 124 has the same polarity as electrode 102 and may serve as an electrode terminal. Electrode tab 110 may then be welded to cap 144, the can 124 is filled with an electrolyte, is crimped over the cap to complete the manufacturing process.

One of the problems of welding electrode tab 112 via aligned openings 134 and central hollow 136 in the manner discussed above is that the procedure is very delicate and requires a very high degree of accuracy. Additionally, laser welders suitable for the welding process are expensive. If the welding process is not carried out perfectly, the electrode assembly 106, including the electrodes 100, 102 or separator 104, might be damaged during the process, which could cause the resulting battery to experience an electrical short or a degradation of battery life. A problem of welding electrode tab 112 through the bottom end 128 of the can 124 is that the electrode tab 112 may be easily damaged. To weld the electrode tab 112 to the bottom end 128, a large amount of heat must be provided to heat the can 124. The can 124 is typically much thicker than the electrode tab 112. For this reason, unless extreme care is taken in heating the can 124, the heat can quickly damage the thinner electrode tab 112.

A boxed portion of the electrode 100, including electrode tab 110, shown in FIG. 1 is illustrated in greater detail for illustrative purposes in FIG. 4. The discussion that follows also applies to electrode 102 and electrode tab 112. When the battery is in use and is being discharged or recharged, electrode tab 110 is electrically connected to either a load or power supply. In either case, current or electrons 138 travel between electrodes 100 and 102 via an external circuit. The direction that the electrons 138 travel depends on whether the battery is being discharged or charged. In traveling from one electrode 100 to the other electrode 102, or vice versa, electrons conventionally travel along the length of the current collector to electrode tab 110, 112. In the case of electrode 100, a single electrode tab 110 is located at one end 140 of the electrode. Electrons 138 located at the opposite end 142 (shown in FIG. 1) of electrode 100 must travel the entire length of the electrode to reach electrode tab 110. The electrical resistance of a given material, such as the electrode material, is directly proportional to its length. Thus, the further that electrons 138 must travel along electrode 100 to reach electrode tab 110, the greater the internal resistance and the lower the effectiveness of the battery. In order to initiate an electrochemical reaction, current must travel length-wise (in direction 120) down the electrode current collector 100 to reach the active material where the charge-transfer reactions take place. This distance varies from one half the length of the wound electrode 100 if the tab 110 is affixed at the electrode's midpoint, to the entire length of the electrode if the tab is affixed at either end. Internal resistance is undesirable in batteries, particularly those batteries intended to handle short but heavy current spikes, such as in the power tools industry. The lower the internal resistance, the less restriction the battery encounters in delivering the needed power spike, and vice versa. A common approach to overcoming high internal resistance is to simply increase the size of the batteries. By oversizing the battery, the required power can be more easily delivered despite the internal resistance. However, oversizing batteries increases their costs and weight, which also is not desirable.

Attempts have been made to address the internal resistance problem by reducing the coating weight of the electrodes 100, 102 and also by increasing the number of electrode tabs 110, 112, such that the distances that electrons 138 travel along the electrode is minimized. Reducing the coating weight of the electrodes 100, 102 reduces the energy density of the cell and increases the power density. As the coat weight is reduced the electrodes become thinner and longer. Longer electrodes require more tabs to be placed, which increases the manufacturing cost and complexity. Also, the larger height of the tab and tape creates a height discontinuity in the electrode compared to the smaller height of the thinner coating of the electrode surrounding the tab and tape. More particularly, the tab and tape added to the electrode results in an area of the electrode that has a thicker cross section than the surrounding electrode that, when wound in a jelly roll (i.e., electrode assembly 106), does not bend like the surrounding electrodes. This results in a jelly roll that is not perfectly round after the winding process and can result in areas of high pressure within the electrode during cycling (expansion and contraction). In addition, the tab placement is limited by performance and safety issues that arise from the need to have anode coating located opposite to cathode coating. When the anode coating is not located opposite the cathode coating, ions in the electrolyte might become plated to the electrode material rather than intercalated into the electrode material. This plating process can lead to dendrite formation that can short circuit the battery causing failure. This phenomenon limits the use of center-placed tabs in the anode (i.e., tabs located in the center of the electrode). Next, placing tabs towards the center of the electrode typically creates a larger discontinuity in the electrode or winding. Lastly, increasing the number of tabs also adds complexity to the manufacturing process. For example, the electrode tabs 110, 112 must be carefully located on the electrodes 100, 102 and aligned, which requires that the winding be carefully carried out. Additionally, creating multiple non-coated portions 108 is more difficult than creating just a single non-coated section.

What is needed, therefore, is a cell design that minimizes the distance that current must travel along the electrode to reach an electrode tab mounted to the electrode. Furthermore, a cell design and a manufacturing process that simplifies the attachment of electrode tabs to electrodes, that reduces the complexity of processing electrodes, and that reduces the risk of damage to electrode tabs and electrodes during the manufacturing process are needed.

### Notes on Construction

The use of the terms “a”, “an”, “the” and similar terms in the context of describing embodiments of the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling, joinder and the like, such as “attached”, “connected” and “interconnected”, “coupled”, and the like are only used to aid the reader's understanding of the present disclosure, and may not create limitations, particularly as to the position, orientation, or use of the elements disclosed herein. These terms may refer to a relationship wherein structures are secured or attached to one another either directly or indirectly through intervening structures, as well as both moveable and rigid attachments or relationships, unless otherwise specified herein or clearly indicated as having a different relationship by context. Therefore, these references, if any, are to be construed broadly. Moreover, such references may not necessarily infer that two elements are directly connected to each other. For example, the term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity. Various embodiments disclosed herein are to be taken in the illustrative and explanatory sense and should in no way be construed as limiting of the present disclosure.

Numerical terms, such as, but not limited to, “first”, “second”, “one”, “another”, or other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification unless otherwise indicated herein or clearly contradicted by context.

It will also be appreciated that one or more of the elements depicted in the drawings/figures can also be implemented in a more separated or integrated manner, or even removed in certain cases, as is useful in accordance with a particular application.

### SUMMARY

The above and other needs are met by an electrode assembly having a first elongate substrate having a top end, a bottom end, a width between the top end and the bottom end, a first end, a second end and a length L1 between the first end and the second end. A first active material composite coats at least a first side of the first substrate. A first electrode tab is formed by an uncoated portion of the first substrate, which uncoated portion extends continuously between the first end and the second end of the first substrate and is located at the top end of the first electrode. The assembly further includes a second elongate substrate having a top end, a bottom end, a width between the top end and the bottom end, a first end, a second end and a length L2 between the first end and the second end. A second active material composite coats at least a first side of the second substrate. A second electrode tab is formed by an uncoated portion of the second substrate, which uncoated portion extends continuously between the first end and the second end of the second substrate and is located at the bottom end of the second electrode. Lastly, an electrically-insulative separator is located between the first substrate and the second substrate. The first substrate and second substrate are stacked together with their respective top ends and bottom ends aligned. The separator is located between the first and second substrates. Finally, the first and second substrates and the separate are rolled about a central axis to form a jelly roll. In certain embodiments, an uncoated offset portion is located at one of the first end or second end of the first substrate. Preferably, the offset portion extends continuously between the top end and the bottom end of the first substrate. The length L2 is shorter than the length L1 such that, when the jelly roll is formed, the offset portion forms an outermost layer of the jelly roll and completely encircles the jelly roll.

According to certain preferred embodiments, a battery assembly is formed using the electrode assembly described above. The battery assembly includes a can that includes a top and a bottom and that also includes a first electrical contact and a second electrical contact. An electrolyte is located in the can. The electrode assembly is inserted into the can and one of the electrode tabs is welded to the first electrical contact and the other electrode tab is welded to the second electrical contact. The electrolyte and electrode assembly are then sealed within the can. In some cases, a lollipop-shaped electrical bridge having a circular portion is welded to one of the electrode tabs at an end of the jelly roll. A flexible ribbon portion extending away from the circular portion is then welded to one of the electrical contacts for electrically connecting the electrode tab to the electrical contact. The lollipop-shaped electrical bridge may include a central hollow that is configured to align with a central hollow in the jelly roll when the electrical bridge is welded to the electrode tab. In some cases, the lollipop-shaped electrical bridge includes a flexible ribbon portion extending away from the circular portion that is welded to one of the electrical contacts, such that the electrode tab is indirectly welded to the electrical contact. In some cases, electrical bridges are located at opposite ends of the jelly roll and each electrical bridge has a first portion that is welded to an electrode tab and a second portion that is welded to an electrical contact of the can, such that the electrode tabs are indirectly welded to the electrical contacts.

In certain embodiments, electrode assembly may include a first crushed portion located at the top end of rolled electrodes, where the jelly roll has been crushed. The assembly also includes an uncrushed portion of the jelly roll located adjacent the crushed end. An electrically-conductive bridge having a circular portion may be welded to the top end of the electrode assembly. In certain embodiments, the electrode assembly may include a second crushed portion located at the bottom end of rolled electrodes, where the jelly roll has been crushed. In some cases, the top and the bottom end of the electrode assembly have the same diameter. In certain embodiments, electrically-conductive bridges that each have a circular portion are welded to each of the top end and bottom ends of the electrode assembly.

Finally, the present disclosure provides a battery cell manufacturing method that includes the steps of providing an electrode assembly having: a first elongate substrate having a top end, a bottom end, a width between the top end and the bottom end, a first end, a second end and a length L1 between the first end and the second end; a first active material composite coating at least a first side of the first substrate; a first electrode tab formed by an uncoated portion of the first substrate extending continuously between the first end and the second end of the first substrate and disposed at the top end of the first electrode; a second elongate substrate having a top end, a bottom end, a width between the top end and the bottom end, a first end, a second end and a length L2 between the first end and the second end; a second active material composite coating at least a first side of the second substrate; a second electrode tab formed by an uncoated portion of the second substrate extending continuously between the first end and the second end of the second substrate and disposed at the bottom end of the second electrode; and an electrically-insulative separator. The method further includes the step of placing the separator between the first substrate and the second substrate such that the first substrate and second substrate are stacked together with their respective top ends and bottom ends aligned and with the separator located between the first and second substrates. Finally, the method provides rolling the stacked first substrate, separator, and second substrate about a central axis to form a jelly roll.

Certain embodiments of the method include crushing a top portion of the jelly roll to provide a first crushed portion. In some cases, the method includes providing a first electrically-conductive bridge having a first portion and a second flexible ribbon portion extending away from the first portion. A can having a first electrical contact is provided. Then, the method includes welding the first portion of a first electrically-conductive bridge to the top surface of the first crushed portion of the jelly roll. Similarly, the method includes welding the flexible ribbon portion of a first electrically-conductive bridge to the first electrical contact of the can.

In certain embodiments of the invention, the disclosed method includes the steps of crushing a bottom portion of the jelly roll to provide a second crushed portion, wherein a bottom surface of the second crushed portion has a third diameter centered on the central axis that is smaller than the second diameter. In certain embodiments, that method includes providing a first electrically-conductive bridge, a second electrically-conductive bridge, and a can having a first electrical contact and a second electrical contact. Then, indirectly welding the top surface of the first crushed portion to the first electrical contact via the first bridge and indirectly welding the bottom surface of the second crushed portion to the second electrical contact via the first bridge. In some cases, the first bridge includes a first portion that is welded to the top surface of the first crushed portion and a second flexible ribbon portion extending away from the first portion of the first bridge that is welded to the first electrical contact. Lastly, in some cases, the method may include providing a can having a first electrical contact and a second electrical contact. Then, inserting the jelly roll into the can, welding the first and second electrode tabs to the first and second electrical contacts, respectively, providing an electrolyte within the can, and sealing the jelly roll and electrolyte within the can.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 depicts conventional plate shaped electrodes and a separator used in forming a jelly roll-type electrode assembly;

FIG. 2 is a perspective view depicting a conventional jelly roll-type electrode assembly formed from the electrodes and separator of FIG. 1;

FIG. 3 is a cross sectional exploded view depicting a conventional battery formed using the electrode assembly of FIG. 2;

FIG. 4 is a detail view depicting a boxed portion, marked “FIG. 4”, of the electrode shown in FIG. 1;

FIGS. 5A and 5B depict opposing sides of plate-shaped electrodes and separators used in forming a jelly roll-type electrode assembly according to an embodiment of the present invention;

FIGS. 6A and 6B are detail views depicting boxed portions, marked “FIG. 6A” and “FIG. 6B”, of the electrode shown in FIG. 5A;

FIG. 7 is a perspective view depicting a jelly roll-type electrode assembly formed from the electrodes and separators of FIGS. 5A and 5B;

FIGS. 8 and 9 are perspective views depicting opposing ends of the electrode assembly of FIG. 7;

FIG. 10 is a perspective view depicting a lollipop-shaped bridge configured to be electrically connected to the continuous tab of one of the electrodes of the electrode assembly of FIG. 7;

FIG. 11 is a perspective view depicting a disc-shaped bridge configured to be electrically connected to the continuous tab of one of the electrodes of the electrode assembly of FIG. 7;

FIG. 12 is a perspective view of a can and cap used in connection with the electrode assembly of FIG. 7 to construct a secondary battery;

FIG. 13 is a cross sectional exploded view depicting a battery formed using the electrode assembly of FIG. 7;

FIGS. 14A-14C depict a cap being connected to an electrode assembly using a lollipop-shaped bridge according to an embodiment of the present invention;

FIG. 15 is a process flow diagram providing a process for constructing a secondary battery having electrodes with continuous tabs according to an embodiment of the present invention; and

FIG. 16 is a table illustrating experimental results of internal resistance measurements obtained from a battery utilizing various combinations of conventional tabs and continuous tabs of the present invention.

### DETAILED DESCRIPTION

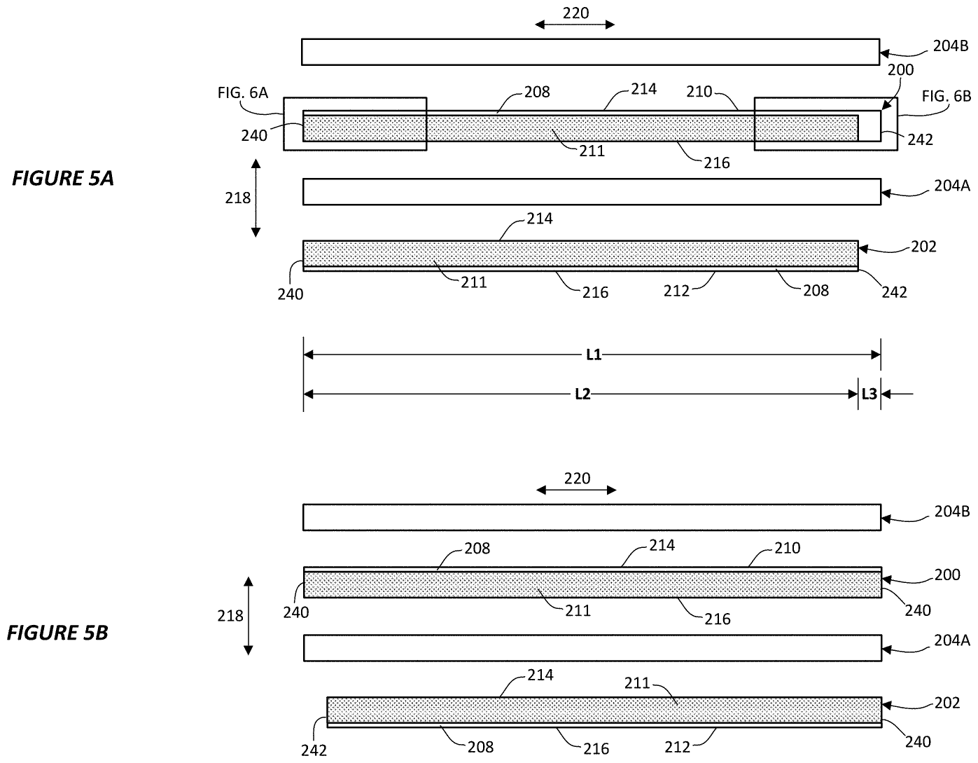

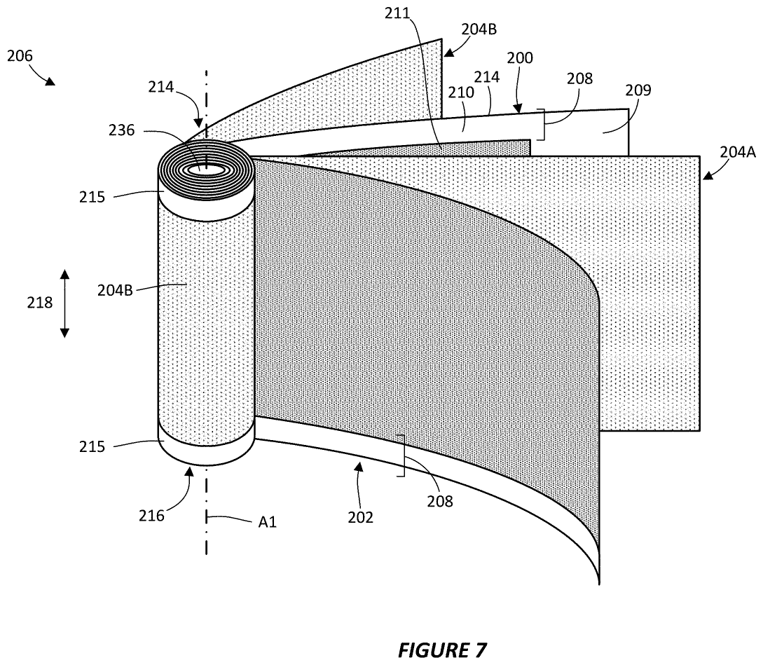

With reference to FIGS. 5A, 5B and 7, two plate-shaped electrodes 200 and 202 and separators 204 (including inner separator 204A and optional outer separator 204B are shown) used in forming a secondary (i.e., rechargeable) battery cell or an electrode assembly 206 according to an embodiment of the present invention are shown. Electrode assembly 206 may be used in forming a single- or multi-cell rechargeable battery. In forming electrode assembly 206, the electrodes 200, 202 and separators 204 are stacked and are then wound together in direction 220 about a central axis A1 such that central hollow 236 is formed. In the illustrated embodiment, electrode 200 is an anode and electrode 202 is a cathode, and separators 204 electrically isolate one electrode (e.g., electrode 200) from the other electrode (e.g., electrode 202) to prevent a short circuit from occurring.

Each of the electrodes 200, 202 is preferably formed by coating one or both sides of a substrate (i.e., collector plate or current collector) with an electrically-conductive active material composite, including either a positive electrode active material composite having a first electrical conductivity, which may comprise one or more of lithium, manganese, iron, nickel, cobalt, etc., or negative electrode active material composite having a second electrical conductivity, which may comprise one or more of graphite, silicon, hard carbon, etc. Combinations of these and other materials known to persons of skill in the art could be used to coat the collector plates to form electrodes 200, 202. Each of the active material composites is typically comprised of a particulate electrode active material, a conductive material, and a binder. The active material composite may also include a plasticizer in a solvent, which is removed during the electrode formation process. The collector plates are typically a metal foil, mesh, etc., typically made of aluminum or copper. The coatings may be deposited on to the electrodes by any means known to persons skilled in the art. These methods include, but are not limited to, mechanical deposition, electromechanical deposition, electrochemical deposition, or any combination of processes known to persons skilled in the art.

In order for an electrode cell to function properly and/or optimally, cathode material should ideally face corresponding anode material across a separator 204 along the entire length of the cathode. If the electrodes 200, 202 are exactly the same length, there is a chance that a portion of one of the electrodes (the outer electrode in the jelly roll, the anode) might extend beyond the other electrode (the inner electrode of the jelly roll, the cathode) once they are wound together. As such, in preferred embodiments, one of the electrodes 200, 202 is slightly longer than the other electrode such that, when the electrodes are wound together, the longer electrode (i.e., electrode 200) provides the final wind and is located on the outside of the jelly roll. In the illustrated embodiment, electrode 200 has an overall length L1 and electrode 202 has an overall length L2. Length L1 is longer than length L2 by length L3. Preferably, length L3 of electrode 200 is sized to extend beyond the end of electrode 202 when the two electrodes are wound together.

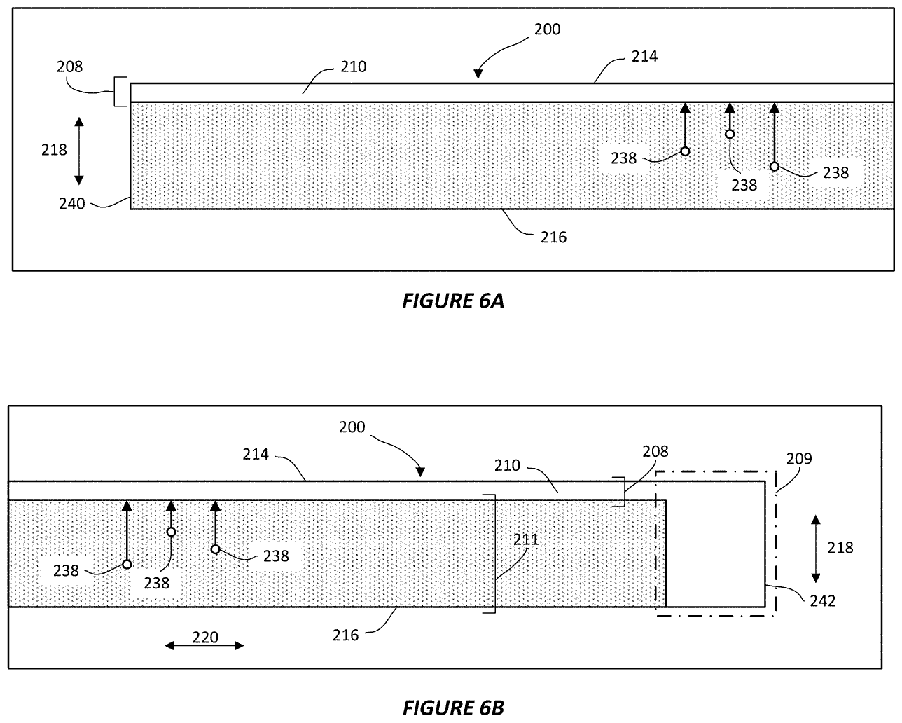

With further reference to FIGS. 6A and 6B, in manufacturing electrodes 200, 202, certain portions of the electrodes are not coated with the active material composite, including uncoated strip portion 208 that preferably extends along the entire length of either the elongate top end 214 or elongate bottom end 216 of the electrodes that form the electrode assembly 206. In certain preferred embodiments, a portion of a longer one of the electrodes 200, 202 is not coated with the electrically-conductive active material composite the coats much of the remainder of the electrode. This provides an uncoated offset portion 209 that is preferably located on only one side and at only one end of one of the electrodes 200, 202, which produces an electrode having a side with an asymmetric coating about a midline in transverse direction 218 that divides the electrode in half. However, the other electrode 200, 202 preferably has a symmetrical coating about a midline in transverse direction 218 that divides the electrode in half. Preferably, the offset portion 209 has a length L3 and that length L3 is sized to completely encircle the entire wound electrode assembly 206. Thus, when the electrodes 200, 202 are wound, the uncoated offset portion 209 forms the entire exterior surface of the electrode assembly 206, which exterior surface faces outwards towards the inner surface of the can.

The total length of the electrodes 200, 202 that may be used is limited by the inside diameter of the can used in the assembly. By leaving a portion of one of the electrodes uncoated (i.e., portion 209), the diameter of the electrode assembly is slightly reduced when compared to the diameter of an electrode assembly formed with electrodes having their entire length coated. Then, by reducing the diameter of the electrode assembly 206, the overall electrode length can be increased, which results in a higher capacity at the cell level. Next, battery materials having performance losses associated with their activation (i.e., first cycle loss) and their use (i.e., capacity fade). By providing a bare or uncoated section on one of the electrodes 200, 202, certain of those losses (i.e., losses that would have occurred at the uncoated portion) may be reduced or possibly even eliminated entirely. Lastly, leaving a portion of the anode uncoated can result in an increased anode yield than a fully-coated anode electrode. For example, in the production of electrode assembly 206, the uncoated portion is created by not coating a certain percentage of the electrode foil. In the illustrate case, the uncoated end is approximately 3-5% of the total anode area. It is anticipated that the uncoated area would result in an approximately 3-5% higher electrode yield compared to a fully-coated anode electrode. Uncoated strip portions 208 function as electrically-conductive electrode tabs 210, 212. Preferably, in forming electrode assembly 206, electrodes 200, 202 are oriented such that one electrode tab 210 is located on one end 214 of one of the electrodes, and the other electrode tab 212 is located on an opposing end 216 of the other electrode. As such, in those preferred cases, no tabs extend above the top end 214 or below the bottom end 216 of the electrodes 200, 202 in transverse direction 218. Electrode tabs 210, 212 preferably extend continuously from end 240 to opposing end 242, in direction 220, on each of the electrodes 200, 202. Direction 220 is parallel with the direction that the electrodes 200, 202 are rolled to form the electrode assembly 206, and direction 218 is preferably orthogonal to direction 220 and is also orthogonal to the direction that the electrodes are rolled to form electrode assembly. In other embodiments, only one electrode is provided with a continuous electrode tab. In those cases, the other electrode may be provided with one or more conventional electrode tabs, such as tab 110 (shown in FIG. 2), which may extend above the top end 214 or below the bottom end 216 of the electrodes 200, 202 and located at any location along the length the electrodes (e.g., at one or both ends 240, 242, at the center, and/or between the center and ends).

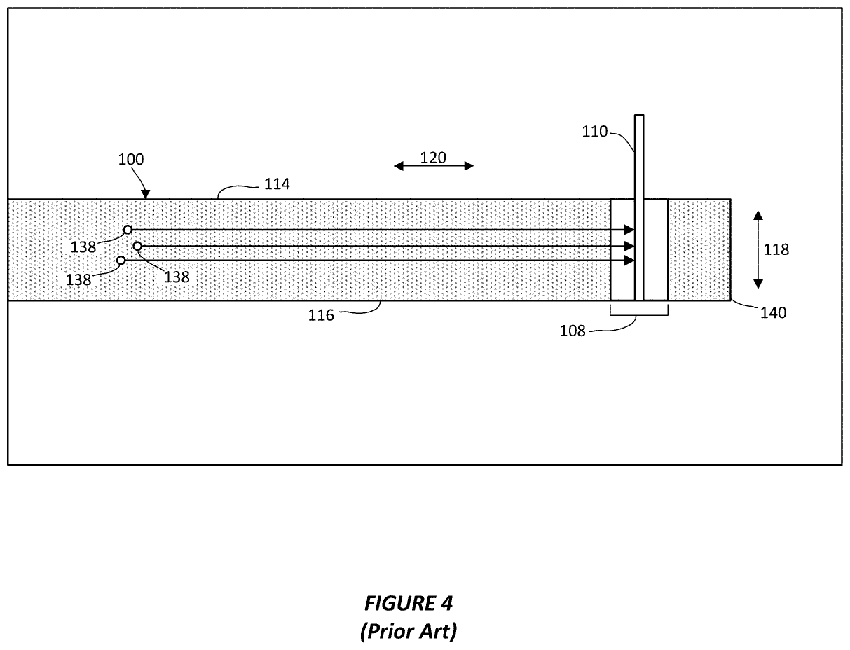

As shown in FIGS. 6A and 6B, electrons 238 travel upwards or downwards in direction 218 to electrode tab 210 (or 212). The distance that electrons 238 must travel to reach the electrode tab 210 is significantly shorter than the distance traveled in conventional electrodes, which is illustrated by electrons 138 in FIG. 4. Therefore, the internal resistance of electrodes 200, 202 is significantly less than that of electrodes 100, 102. This reduction in internal resistance increases the battery response time and reduces the size and cost of battery needed to handle short, heavy power spikes that are typical of power tools and the like.

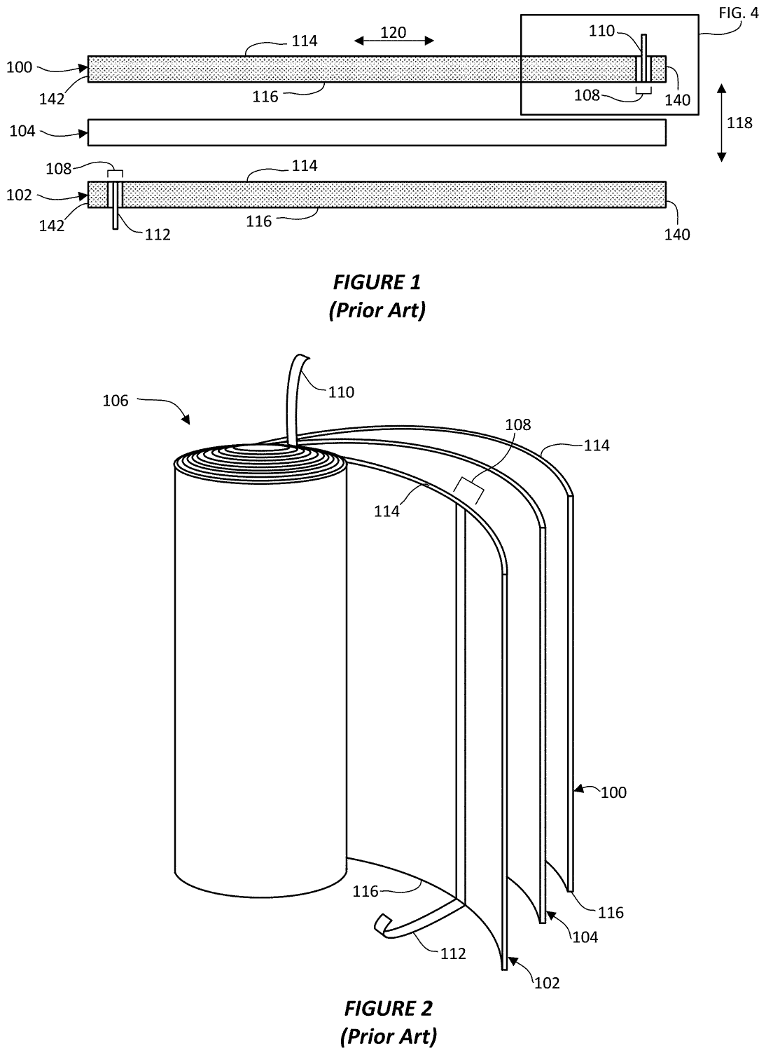

With reference to FIGS. 5A, 5B, 7, as previously mentioned, electrodes 200, 202 and separators 204 may be stacked and wound about central axis A1 to form a jelly roll-type electrode assembly 206. This design eliminates a substantial amount of processing time and steps of conventional electrode assembly designs. Advantageously, unlike the many conventional electrode assemblies, including electrode assembly 106 (FIG. 1), no additional processing of the electrodes 200, 202 is required between the coating process and the rolling process. In particular, the bare (i.e., uncoated) strip portions 208 require no further processing (e.g., tabbing and taping) to function as a tab. Also, there is no need to align tabs since the electrodes 200, 202 each contain a single and continuous integrated tab. In the illustrated embodiment, uncoated strip portion 208 of electrode 200 (i.e., the cathode) is 3-4 mm in height (in direction 218), coated portion 211 is 58 mm in height, and the overall height of the electrode is 61-62 mm. Similarly, uncoated portion strip 208 of electrode 202 (i.e., the anode) is 3-4 mm in height (in direction 218), coated portion 211 is 56 mm in height, and the overall height is 59-60 mm.

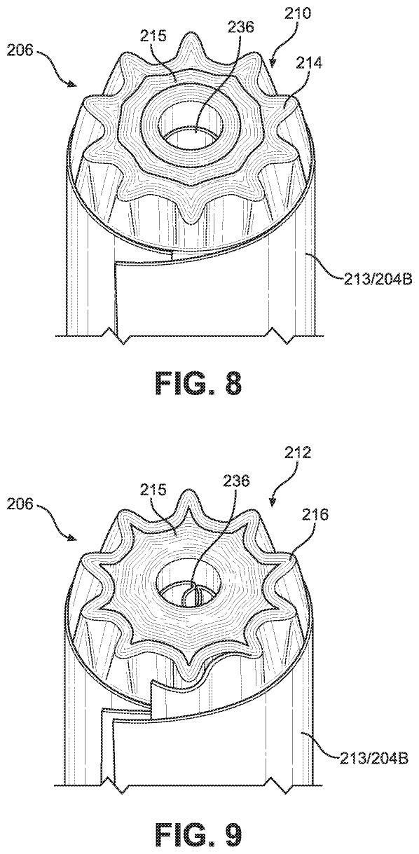

With further reference to FIGS. 8 and 9, when electrode assembly 206 has been rolled, an outer insulating center cover portion 213 preferably covers an exterior portion of the electrode assembly. In some embodiments center cover portion 213 is covered by separator 204B (shown in FIG. 7). In other embodiments, a separately applied material is externally applied to the electrode assembly 206 as the center cover portion 213. The center cover portion 213 is sized such that portions 215 of the electrode tabs 210, 212 are exposed on either end of the electrode assembly 206. Thus, unlike conventional electrode assemblies, the separators 204A and 204B of the presently-disclosed electrode assembly 206 are preferably narrower than the electrodes 200 and 202 (in transverse direction 218). In certain preferred embodiments, each exposed portion 215 is 1-1.5 mm in height, each center cover portion 213 is 60 mm in height, and the overall height of each electrode assembly is 62-63 mm, where each of the above-mentioned “heights” is measured in direction 218, as shown in FIG. 7. With continued reference to FIGS. 8 and 9, after the electrode assembly 206 has been rolled, each end 214, 216 is comprised of several concentric layers formed by continuous electrode tabs 210, 212. Exposed portions 215 may be crimped, deformed or contoured in order collapse the layers of electrode tabs 210, 212 together and to make each of the ends 214, 216 more dense.

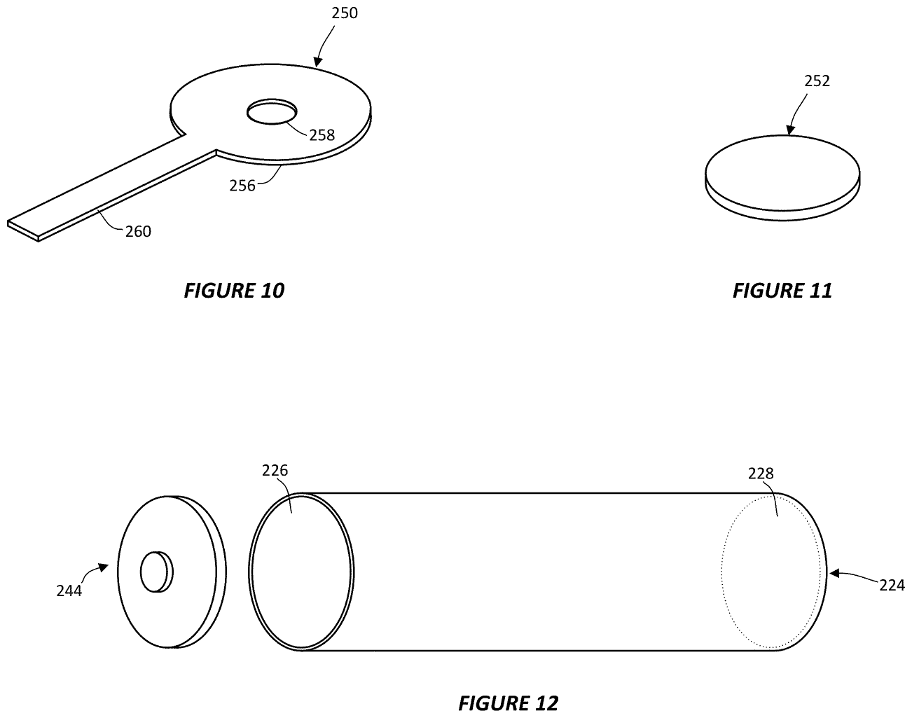

Referring to FIGS. 10 and 11, electrically-conductive bridge 250 and electrically-conductive bridge 252 are illustrated. Bridge 250 is lollipop-shaped, including a circular portion 256 and a flexible ribbon portion 260 attached to the perimeter of the circular portion. The lollipop-shaped bridge 250 can be formed as a single unit or constructed from multiple connected parts. In certain preferred embodiments, bridge 250 includes a central hollow 258 formed in the circular portion 256. On the other hand, bridge 252 is preferably a solid disc having no openings. With further reference to FIGS. 8 and 9, each of the bridges 250 and 252 are designed to be welded onto an end 214, 216 of the electrode assembly 206. Therefore, crimping, deforming, or contouring the exposed portions 215 to provide a dense, compacted surface at end each end 214, 216 facilitates the welding of bridges 250, 252 to the electrode tabs 210, 212. In preferred embodiments, bridge 250 is welded onto one end 214 of electrode assembly 206 such that central hollow 258 aligns with central hollow 236 of electrode assembly 206. As used herein, the term “weld” means to fixedly join or fusing two material together, including through the use of high or low temperatures, including brazing and soldering. For example, as used above, the term “weld” means that the bridges 250, 252 are fixedly attached (i.e., permanently or at least semi-permanently attached) to the electrode tabs 210, 212 in order that current may flow between them.

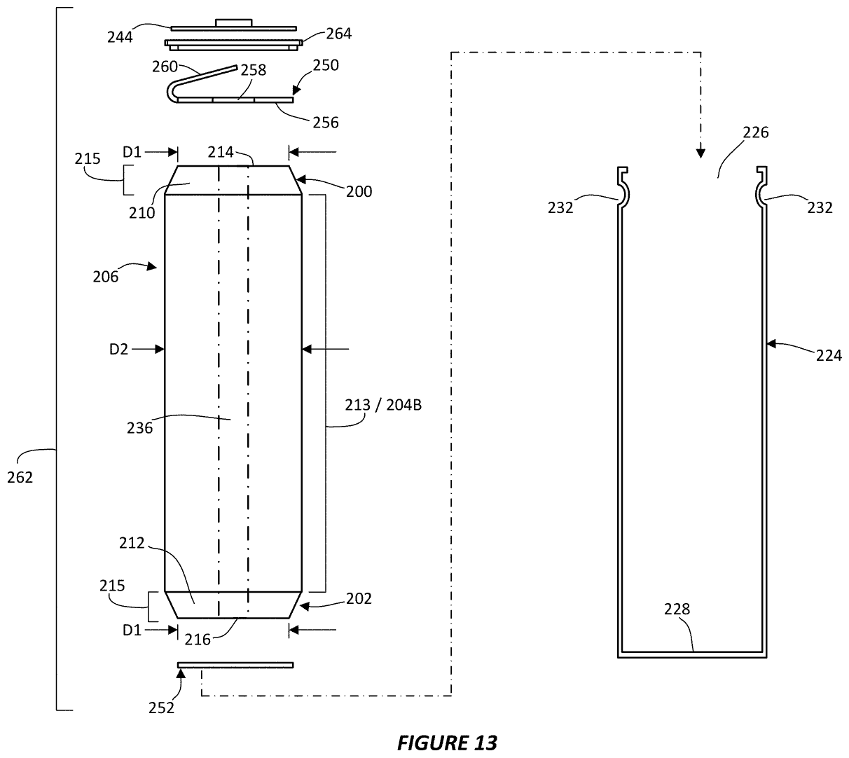

Bridges 250, 252 connect the electrode assembly 206 to a can 224 (first electrical contact) and corresponding cap 244 (second electrical contact), which are both illustrated in FIG. 12. When connected in such manner, the can 224 functions as a first electrical contact and the cap 244 functions as a second electrical contact. While conventional tabs, such as tabs 110 and 112 (shown in FIG. 2) could be used with electrode assembly 206 in forming the connection with either can 224 or cap 244, bridge 250 and 252 simplify and improve the manufacturing process, as discussed below. With reference to FIG. 13, by welding circular portion 256 of bridge 250 to the top of the exposed portion 215 of end 214 (in this case, the cathode) of electrode assembly 206, the bridge may be electrically connected to the entire length of electrode tab 210 (i.e., from end 240 to end 242, shown in FIG. 5A, 5B). This provides a very short pathway for electrons to flow from electrode 200 and out of the electrode assembly 206 via bridge 250, thus providing a lower internal resistance compared to the internal resistance of conventional designs that utilize tabs. Next, the flexible ribbon portion 260 is bent upwards, passed through gasket 264 and then welded to cap 244.

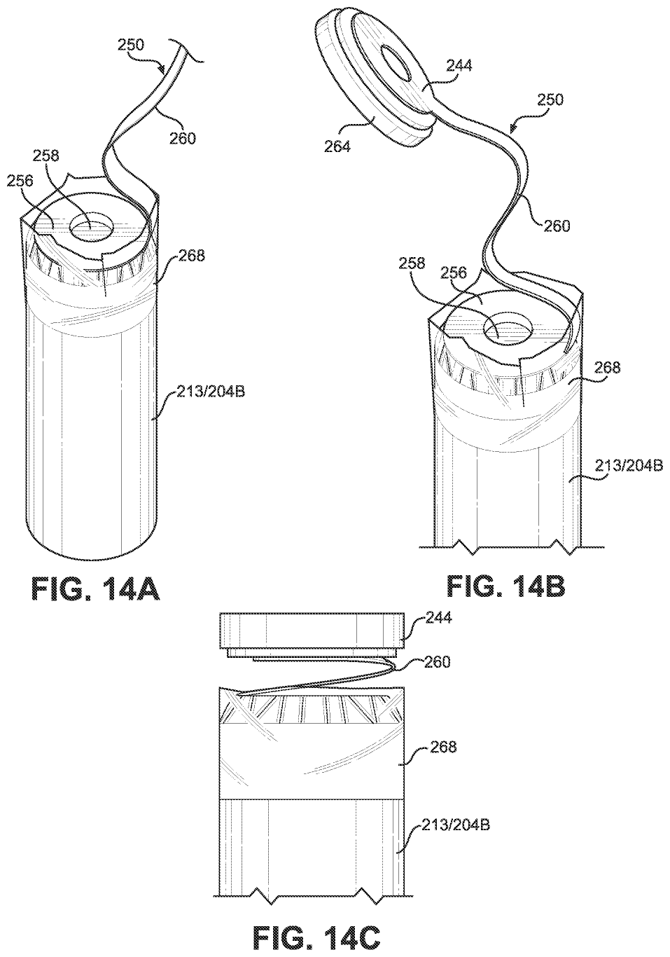

Next, it important to prevent the cap 244, bridge 250, and electrode tab 210, which all have one polarity, from contacting the can 224, bridge 252, or electrode tab 212, which all have a different polarity. Contact between any two components with different polarities could create a short circuit and degrade the life of the cell. For that reason, as shown in FIGS. 14A-14C, an insulator 268 is preferably placed around any areas of exposure where cap 244, bridge 250, or electrode tab 210 (which, individually or collectively, may be considered a first electrical contact) could contact can 224, bridge 252, or electrode tab 212 (which, individually or collectively, may be considered a second electrical contact). Insulator 268 may comprise one or more of any appropriate insulating material, including an insulating (e.g., plastic) disc or cap, such as gasket 264, non-conductive tape, such as Kapton® brand tape, or any other non-conductive polymer or other material.

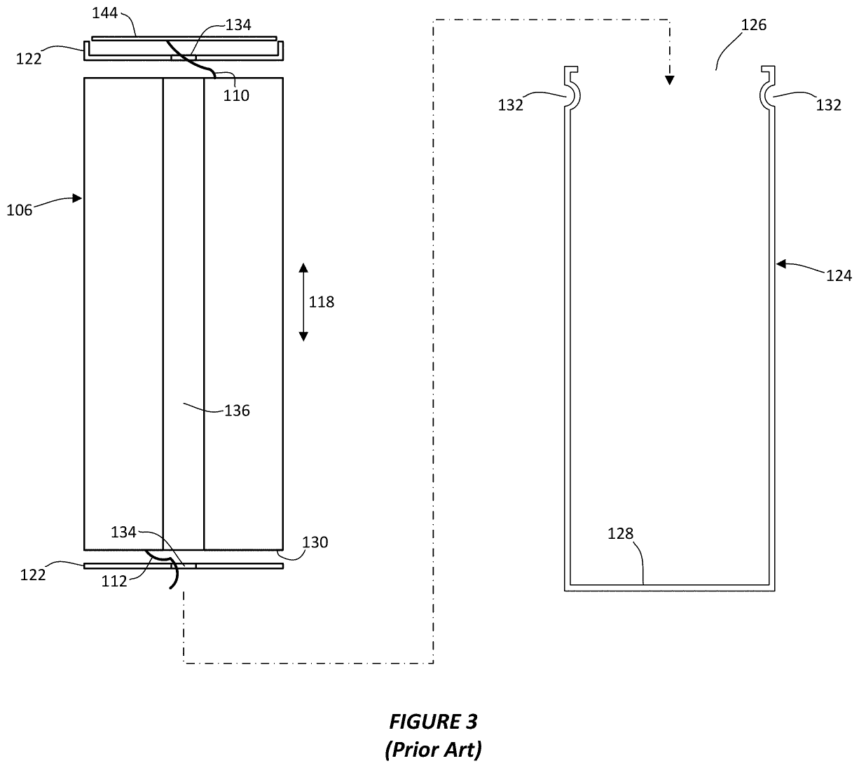

Referring again to FIG. 3, bridge 252 may be easily welded onto the opposite end 216 (in this case, the anode) of electrode assembly 206 while they are located outside of the can 224. Again, advantageously, by welding the disc-shaped bridge 252 to the bottom of the exposed portion 215 of end 216 of electrode assembly 206, the bridge is connected to the entire length of electrode tab 212 (i.e., from end 240 to end 242, shown in FIG. 5A, 5B). This provides a very short pathway for electrons to flow from electrode 200 and out of the electrode assembly 206 via bridge 250, thus providing a lower internal resistance compared to the internal resistance of conventional designs that utilize tabs.

The entire battery assembly 262, which preferably includes electrode assembly 206 as well as bridges 250, 252 welded to the electrode assembly, gasket 264, and cap 244, is inserted into can 224 via a top opening 226. As shown in FIG. 13, by deforming or crushing each end 214, 216, the cross-sectional area of the ends of the electrode assembly 206 are preferably smaller than the cross-sectional areas of the uncrushed portions of the electrode assembly, including those areas between the ends that has not been deformed. In preferred embodiments, a diameter D1 of each of the ends 214, 216 is equal. Additionally, diameter D1 of the ends 214, 216 are preferably smaller than a diameter D2 of the area of the electrode assembly 206 located between the ends and are also smaller than the diameter of the inside of the can 224. As used herein, the terms “crush” or “crushed” should be interpreted broadly to mean any operation that compacts, reduces the cross sectional area, or makes the ends of the electrode assembly 206 more dense such that the size of the crushed portions of the electrode assembly are smaller than the uncrushed portions of the electrode assembly. However, the terms “crush” and “crushed” exclude operations that remove material from the electrode assembly in order to reduce its size. The diameter of the circular portion 256 of bridge 250 and the diameter of bridge 252 are approximately equal to the diameter D1 of the ends 214, 216. Accordingly, the bridges 250, 252 substantially cover but do not extend beyond the outermost perimeter of the deformed ends 214, 216. This ensures that the entire lengths of electrode tabs 210, 212 are electrically connected to the bridges 250, 252, respectively, and also facilitates the insertion of the ends 214, 216 into the can 224.

After assembly 262 is inserted into the can 224, bridge 250 is positioned near top opening 226 and bridge 252 is positioned near bottom 228. In this illustrated embodiment, bottom 228 is integrally formed with the can 224 and cap 244 is a separate component that covers opening 226. However, in other embodiments, the bottom 228 may be removable from the can 224 and used to cover a lower opening (not shown) in the can and cap 244 may be integrally formed with the can. In still further embodiments, both ends may be removable from the can 224.

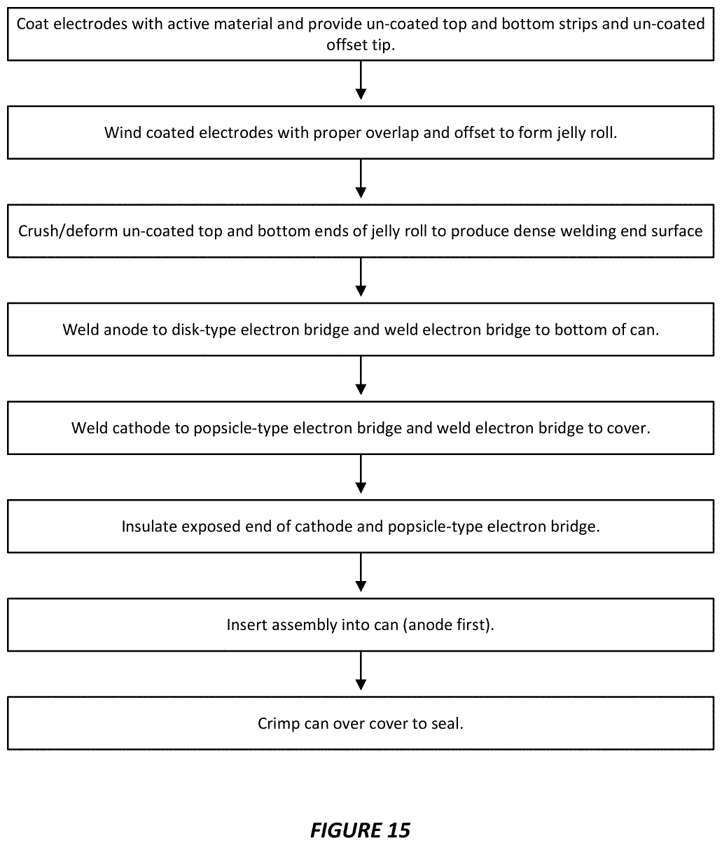

In the illustrated embodiment, since the central hollow 258 was aligned with central hollow 236 when welding bridge 250 to end 214, as described above, a welding rod or laser welder may be directed down through the aligned openings to weld bridge 252 to the bottom 228 of the can 224. Alternatively, resistance or laser welding may be used to weld bridge 252 to the bottom 228 of the can 224 through the bottom of the can. In this way, can 224 has the same polarity as electrode 212 and may serve as an electrode terminal. In preferred embodiments, bridge 252 has a thickness that is approximately equal to the wall thickness of can 224 and that is thicker than conventional electrode tabs, such as electrode tab 112 (shown in FIG. 2). The increased thickness of bridge 252 (when compared to conventional electrode tabs) helps to overcome the problem of damaging thinner bottom electrode tabs that are conventionally welded to the can via the bottom end. Lastly, a top surface of cap 244 is positioned below a crimp 232 in in the can 224 order to secure the assembly 262 within the can and complete the assembly. The above-described process is shown in a flow diagram provided in FIG. 15.

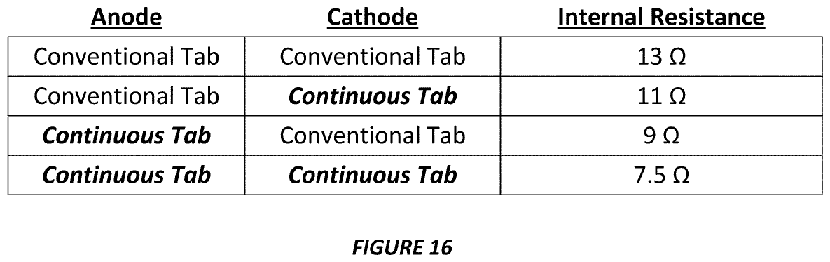

The table shown in FIG. 16 provides experimental results of internal resistance measurements (in milliohms, mΩ) obtained from a battery utilizing various combinations of conventional tabs (tabs 110, 112, shown in FIG. 2) and continuous tabs (electrode tabs 210, 212, shown in FIG. 7) of the present invention.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. An electrode assembly comprising:
a first elongate substrate having a top end, a bottom end, a width between the top end and the bottom end, a first end, a second end and a length L1 between the first end and the second end;
a first active material composite coating at least a first side of the first substrate;
a first electrode tab formed by an uncoated portion of the first substrate extending continuously between the first end and the second end of the first substrate and disposed at the top end of the first electrode;
a second elongate substrate having a top end, a bottom end, a width between the top end and the bottom end, a first end, a second end and a length L2 between the first end and the second end;
a second active material composite coating at least a first side of the second substrate;
a second electrode tab formed by an uncoated portion of the second substrate extending continuously between the first end and the second end of the second substrate and disposed at the bottom end of the second electrode;
an electrically-insulative separator disposed between the first substrate and the second substrate,
wherein the first substrate and second substrate are stacked together with their respective top ends and bottom ends aligned and with the separator located between the first and second substrates, which are then rolled about a central axis to form a jelly roll.

2. The electrode assembly of claim 1 further comprising an uncoated offset portion located at one of the first end or second end of the first substrate, wherein the offset portion extends continuously between the top end and the bottom end of the first substrate.

3. The electrode assembly of claim 2 wherein length L2 is shorter than length L1 such that, when the jelly roll is formed, the offset portion forms an outermost layer of the jelly roll and completely encircles the jelly roll.

4. A battery assembly formed using the electrode assembly of claim 1, the battery assembly comprising:
a can that includes a top and a bottom and that also includes a first electrical contact and a second electrical contact;
an electrolyte disposed in the can; and
said electrode assembly inserted into the can and one of the electrode tabs welded to the first electrical contact and the other electrode tab welded to the second electrical contact, wherein the electrolyte and electrode assembly are sealed within the can.

5. The battery of claim 4 further comprising a lollipop-shaped electrical bridge having a circular portion that is welded to one of the electrode tabs at an end of the jelly roll and a flexible ribbon portion extending away from the circular portion that is welded to one of the electrical contacts for electrically connecting said one electrode tab to said one electrical contact.

6. The battery of claim 5 wherein the circular portion of the lollipop-shaped electrical bridge includes a central hollow that is configured to align with a central hollow in the jelly roll when the electrical bridge is welded to an end of said one electrode tab.

7. The battery of claim 6 wherein the lollipop-shaped electrical bridge includes a flexible ribbon portion extending away from the circular portion that is welded to one of the electrical contacts, such that said one electrode tab is indirectly welded to said one electrical contact.

8. The battery of claim 4 further comprising electrical bridges located at opposite ends of the jelly roll and each electrical bridge having a first portion welded to an electrode tab and a second portion welded to an electrical contact of the can, such that the electrode tabs are indirectly welded to the electrical contacts.

9. An electrode assembly comprising:
a first elongate substrate having a top end, a bottom end, a width between the top end and the bottom end, a first end, a second end and a length L1 between the first end and the second end;
a first active material composite coating at least a first side of the first substrate;
a first electrode tab disposed at the top end of the first electrode;
a second elongate substrate having a top end, a bottom end, a width between the top end and the bottom end, a first end, a second end and a length L2 between the first end and the second end;
a second active material composite coating at least a first side of the second substrate;
a second electrode tab disposed at the bottom end of the second electrode;
an electrically-insulative separator disposed between the first substrate and the second substrate, wherein the first substrate and second substrate are stacked together with their respective top ends and bottom ends aligned and with the separator located between the first and second substrates, which are then rolled about a central axis to form a jelly roll;
a first crushed portion located at the top end of the rolled electrodes where the jelly roll has been crushed; and
an uncrushed portion of the jelly roll located adjacent the first crushed portion.

10. The electrode assembly of claim 9 further comprising an electrically-conductive bridge having a circular portion that is welded to the top end of the electrode assembly.

11. The electrode assembly of claim 9 further comprising a second crushed portion located at the bottom end of the electrodes where the jelly roll has been crushed.

12. The electrode assembly of claim 11 wherein the top end and the bottom end have substantially the same diameter.

13. The electrode assembly of claim 11 further comprising electrically-conductive bridges that each have a circular portion welded to each of the top end and bottom end of the electrode assembly.

14. A battery cell manufacturing method comprising the steps of:
providing an electrode assembly having:
a first elongate substrate having a top end, a bottom end, a width between the top end and the bottom end, a first end, a second end and a length L1 between the first end and the second end;
a first active material composite coating at least a first side of the first substrate;
a first electrode tab formed by an uncoated portion of the first substrate extending continuously between the first end and the second end of the first substrate and disposed at the top end of the first electrode;
a second elongate substrate having a top end, a bottom end, a width between the top end and the bottom end, a first end, a second end and a length L2 between the first end and the second end;
a second active material composite coating at least a first side of the second substrate;
a second electrode tab formed by an uncoated portion of the second substrate extending continuously between the first end and the second end of the second substrate and disposed at the bottom end of the second electrode;
an electrically-insulative separator
placing the separator between the first substrate and the second substrate such that the first substrate and second substrate are stacked together with their respective top ends and bottom ends aligned and with the separator located between the first and second substrates; and
rolling the stacked first substrate, separator, and second substrate about a central axis to form a jelly roll.

15. The method of claim 14 further comprising the steps of crushing a top portion of the jelly roll to provide a first crushed portion.

16. The method of claim 15 further comprising the steps of:
providing a first electrically-conductive bridge having a first portion and a second flexible ribbon portion extending away from the first portion;
providing a can having a first electrical contact;
welding the first portion of a first electrically-conductive bridge to the top surface of the first crushed portion of the jelly roll; and
welding the flexible ribbon portion of a first electrically-conductive bridge to the first electrical contact of the can.

17. The method of claim 15 further comprising the steps of crushing a bottom portion of the jelly roll to provide a second crushed portion.

18. The method of claim 17 further comprising the steps of:
providing a first electrically-conductive bridge;
providing a second electrically-conductive bridge;
providing a can having a first electrical contact and a second electrical contact;
indirectly welding the top surface of the first crushed portion to the first electrical contact via the first bridge;
indirectly welding the bottom surface of the second crushed portion to the second electrical contact via the first bridge.

19. The method of claim 18 wherein the first bridge includes a first portion that is welded to the top surface of the first crushed portion and a second flexible ribbon portion extending away from the first portion of the first bridge that is welded to the first electrical contact.

20. The method of claim 18 further comprising the steps of:
providing a can having a first electrical contact and a second electrical contact;
inserting the jelly roll into the can;
welding the first and second electrode tabs to the first and second electrical contacts, respectively;
providing an electrolyte within the can; and
sealing the jelly roll and electrolyte within the can.
